(19) United States
(12) Patent Application Publication
(10) Pub. No.: US 2022/0150900 A1
(43) Pub. Date: May 12, 2022

(54) WIRELESS COMMUNICATION SYSTEM AND APPARATUS AND METHOD FOR DETERMINING A NETWORK TRANSMISSION MECHANISM

(71) Applicant: Institute For Information Industry, Taipei (TW)

(72) Inventors: Shin-Lin SHIEH, Taipei (TW); Yu-Chih HUANG, Taipei (TW); Yu-Pin HSU, Taipei (TW); Ting-YI CHU, Taipei (TW)

(21) Appl. No.: 17/102,415

(22) Filed: Nov. 23, 2020

(30) Foreign Application Priority Data
Nov. 12, 2020 (TW) 109139502

(51) Int. Cl. H04W 72/08; H04W 72/04; H04B 17/309; H04W 28/08

(52) U.S. Cl. CPC H04W 72/082; H04W 28/0925; H04B 17/309; H04W 72/0493

(57) ABSTRACT

A wireless communication system and an apparatus and method for determining a network transmission mechanism are provided. The apparatus stores several transmission policies. Each transmission policy corresponds to a predetermined strength distribution and includes a first predetermined transmission mechanism and a second predetermined transmission mechanism. The apparatus determines a real strength distribution among several terminal apparatuses according to their signal strength, determines a selected policy based on the real strength distribution and the predetermined strength distributions, and determines a user transmission mechanism for each terminal apparatus. Each user transmission mechanism includes the first predetermined transmission mechanism and/or the second predetermined transmission mechanism of the selected policy. The network transmission mechanism includes the user transmission mechanisms. The apparatus transmits an indication signal to each terminal apparatus to inform of the corresponding user transmission mechanism. Each terminal apparatus transmits data according to the corresponding user transmission mechanism.

This application claims priority to Taiwan Patent Application No. 109139502 filed on Nov. 12, 2020, which is incorporated herein by reference in its entirety.

### CROSS-REFERENCES TO RELATED APPLICATIONS

Not applicable.

### BACKGROUND

### Technical Field

The present disclosure relates to a wireless communication system and an apparatus and a method for determining a network transmission mechanism. More specifically, the present disclosure relates to a wireless communication system and an apparatus and a method for determining a network transmission mechanism which adopt an uncoordinated multiple access technology.

### Descriptions of the Related Art

Multiple access technology in wireless communication can be classified into coordinated multiple access technology and uncoordinated multiple access technology. The coordinated multiple access technology needs a receiver (i.e., an apparatus that provides communication services, such as base station, access point, and satellite) to coordinate transmission resources (e.g., time slot) among multiple terminal apparatuses (e.g., user apparatuses, machine-type communication apparatuses) in advance, which consumes huge amount of system resources and, thus, causes the invention of the uncoordinated multiple access technology. The uncoordinated multiple access technology does not need to coordinate transmission resources among multiple terminal apparatuses in advance. Instead, the uncoordinated multiple access technology allows the terminal apparatuses to transmit data randomly.

Slotted Aloha is a conventional uncoordinated multiple access technology. According to the slotted Aloha, every terminal apparatus can choose one or more time slots to transmit data. If data collide due to multiple terminal apparatuses using the same time slot to transmit data, the receiver will be unable to decode the data of the time slot and the receiver will not send a response signal to the terminal apparatuses. As these terminal apparatuses do not receive a response signal, they will select another time slot to transmit data again after a period of time. Although using the slotted Aloha technology will not consume huge amount of system resources, it will result in low transmission efficiency due to data collision. Irregular repetition slotted Aloha (IRSA) is another conventional uncoordinated multiple access technology, which improves the transmission efficiency of the slotted Aloha by using interference cancellation mechanism, using repeated transmission mechanism, and having a buffer in a receiver to temporarily store undecoded data. Nevertheless, the improvement can still be enhanced by adopting recent technologies.

In view of the above situation, there is an urgent need for an uncoordinated multiple access technology which will not consume a plenty of system resources and which will result in high transmission efficiency.

### SUMMARY

An objective of the present invention is to provide an apparatus for determining a network transmission mechanism. The apparatus comprises a storage, a processor, and a transceiver, wherein the processor is electrically connected to the storage and the transceiver. The storage stores a plurality of transmission policies, wherein each of the transmission policies corresponds to a predetermined strength distribution, and each of the transmission policies includes a first predetermined transmission mechanism and a second predetermined transmission mechanism. The processor determines a real strength distribution among a plurality of terminal apparatuses according to a plurality of signal strengths respectively corresponding to the terminal apparatuses, determines a selected policy from the transmission policies based on the real strength distribution and the predetermined strength distributions, and determines a user transmission mechanism for each of the terminal apparatuses. Each of the user transmission mechanisms includes at least one of the first predetermined transmission mechanism and the second predetermined transmission mechanism of the selected policy, and the network transmission mechanism includes the user transmission mechanisms. The transceiver transmits an indication signal to each of the terminal apparatuses individually to inform of the corresponding user transmission mechanism so that each of the terminal apparatuses transmits data according to the corresponding user transmission mechanism.

Another objective of the present invention is to provide a method for determining a network transmission mechanism, which is for use in an electronic computing apparatus. The electronic computing apparatus stores a plurality of transmission policies, wherein each of the transmission policies corresponds to a predetermined strength distribution, and each of the transmission policies includes a first predetermined transmission mechanism and a second predetermined transmission mechanism. The method comprises the following steps: (a) determining a real strength distribution among a plurality of terminal apparatuses according to a plurality of signal strengths respectively corresponding to the terminal apparatuses, (b) determining a selected policy from the transmission policies based on the real strength distribution and the predetermined strength distributions, (c) determining a user transmission mechanism for each of the terminal apparatuses, wherein each of the user transmission mechanisms includes at least one of the first predetermined transmission mechanism and the second predetermined transmission mechanism of the selected policy, and (d) transmitting an indication signal to each of the terminal apparatuses individually to inform of the corresponding user transmission mechanism so that each of the terminal apparatuses transmits data according to the corresponding user transmission mechanism.

Yet another objective of the present invention is to provide a wireless communication system, wherein the wireless communication system comprises an electronic computing apparatus (e.g., base station and satellite) and a plurality of terminal apparatuses (e.g., user apparatuses and machine-type communication apparatuses). The electronic computing apparatus stores a plurality of transmission policies, wherein each of the transmission policies corresponds to a predetermined strength distribution and each of the transmission policies includes a first predetermined transmission mechanism and a second predetermined transmission mechanism. The terminal apparatuses are attached to the electronic computing apparatus. The electronic computing apparatus determines a real strength distribution among the terminal apparatuses according to a plurality of signal strengths respectively corresponding to the terminal apparatuses, determines a selected policy from the transmission policies based on the real strength distribution and the predetermined strength distributions, and determines a user transmission mechanism for each of the terminal apparatuses. Each of the user transmission mechanisms includes at least one of the first predetermined transmission mechanism and the second predetermined transmission mechanism of the selected policy, and the network transmission mechanism includes the user transmission mechanisms. The electronic computing apparatus further transmits an indication signal to each of the terminal apparatuses individually to inform of the corresponding user transmission mechanism, and each of the terminal apparatuses transmits data according to the corresponding user transmission mechanism.

The technology (including at least the wireless communication system and the apparatus and method for determining a network transmission mechanism) provided by the present invention utilizes the characteristic of non-orthogonal multiple access (NOMA) technology that two pieces of data transmitted with different signal strengths can be decoded from a transmission resource. The technology provided by the present invention formulates a plurality of transmission policies, wherein each of the transmission policies corresponds to a predetermined strength distribution, and each of the transmission policies includes a first predetermined transmission mechanism and a second predetermined transmission mechanism. Besides, each of the first predetermined transmission mechanisms corresponds to a first strength level, and each of the second predetermined transmission mechanisms corresponds to a second strength level. The technology provided by the present invention further selects one of the transmission policies as a selected policy based on a real strength distribution of all the terminal apparatuses in the wireless communication system. Then, the technology provided by the present invention have some terminal apparatuses in the wireless communication system adopt the first predetermined transmission mechanism of the selected policy and have the rest terminal apparatuses in the wireless communication system adopt the second predetermined transmission mechanism of the selected policy. By the aforementioned approach, the technology provided by the present invention can increase the probability that two pieces of data in the same transmission resource are transmitted with different signal strengths and thereby make the wireless communication system have a high transmission efficiency. In addition, because the technology provided by the present invention works well even without coordinating transmission resources among multiple terminal apparatuses in advance, additional system resources for coordination is not consumed.

The detailed technology and exemplary embodiments implemented for the present invention are described in the following paragraphs accompanying the appended drawings for a person having ordinary skill in the art to well appreciate the features of the claimed invention.

### BRIEF DESCRIPTION OF THE DRAWINGS

FIG. 1A depicts a schematic view of the wireless communication system 1 of a first embodiment.

FIG. 1B depicts a specific example of the transmission policies 10, 12, and 14.

FIG. 2 depicts a main flowchart of a method of a second embodiment.

### DETAILED DESCRIPTION

In the following description, the wireless communication system and the apparatus and a method for determining a network transmission mechanism provided by the present invention will be explained with reference to embodiments thereof. However, these embodiments are not intended to limit the present invention to any environment, applications, or implementations described in these embodiments. Therefore, description of these embodiments is only for purpose of illustration rather than to limit the present invention. It should be appreciated that, in the following embodiments and the attached drawings, elements unrelated to the present invention are omitted from depiction. In addition, dimensions of and dimensional scales among individual elements in the attached drawings are provided only for illustration, but not to limit the scope of the present invention.

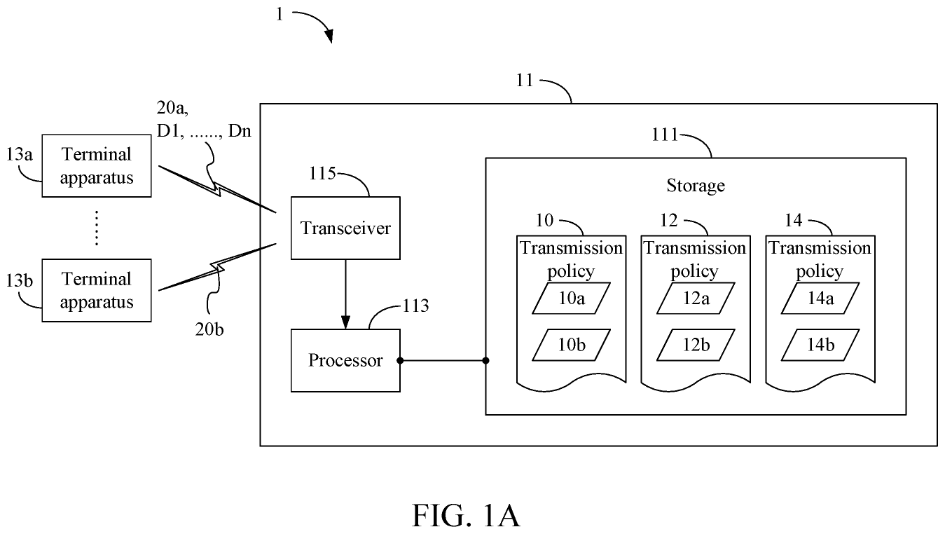

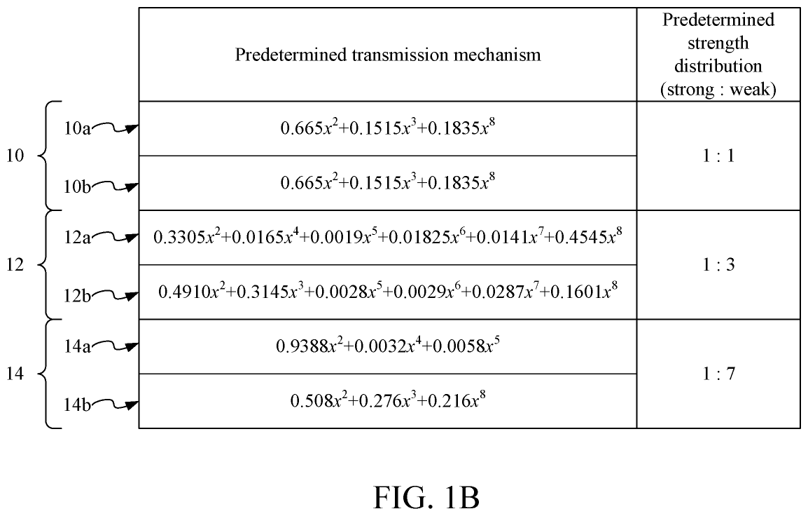

A first embodiment of the present invention is a wireless communication system 1, and a schematic view thereof is depicted in FIG. 1. The wireless communication system 1 comprises an electronic computing apparatus, which is an apparatus for determining a network transmission mechanism (hereinafter referred to as “determination apparatus”) 11. The wireless communication system 1 further comprises a plurality of terminal apparatuses 13a, . . . , 13b. The determination apparatus 11 may be apparatuses that can provide communication services such as a base station, an access point, or a satellite (but it is not limited thereto), and the terminal apparatuses 13a, . . . , 13b may be apparatuses that require communication services such as user apparatuses, machine-type communication apparatuses (but it is not limited thereto).

The determination apparatus 11 comprises a storage 111, a processor 113, and a transceiver 115, wherein the processor 113 is electrically connected to the storage 111 and the transceiver 115. The storage 111 may be a memory, a Universal Serial Bus (USB) disk, a mobile disk, a Compact Disk (CD), a Digital Versatile Disc (DVD), a Hard Disk Drive (HDD), or any other non-transitory storage medium or apparatus with the same function and well-known to a person having ordinary skill in the art. The processor 113 may be one of various processors, Central Processing Units (CPUs), Microprocessors (MPUs), Digital Signal Processors (DSPs), or other computing devices known to a person having ordinary skill in the art. The transceiver 115 may be any wireless transmission interface (e.g., an antenna) known to a person having ordinary skill in the art, which is configured to connect to an apparatus that can provide communication services.

The storage 111 stores three transmission policies 10, 20 and 14. The aforesaid number of the transmission policies 10, 12, and 14 is only an example. The present invention does not limit the number of transmission policies stored in the storage 111 to any specific number as long as it is plural. Each of the transmission policies 10, 12, and 14 corresponds to a predetermined strength distribution. Each of the predetermined strength distributions may be a distribution of strong terminal apparatuses (e.g., terminal apparatuses whose signal strengths are higher than a threshold from the viewpoint of the determination apparatus) and weak terminal apparatuses (e.g., terminal apparatuses whose signal strengths are lower than a threshold from the viewpoint of the determination apparatus) in a wireless communication system (e.g. the ratio of the number of the strong terminal apparatuses to the number of the weak terminal apparatuses, or the percentages of the two types of terminal apparatus). Please refer to a specific example of the transmission policies 10, 12, and 14 shown in FIG. 1B for better understanding, which, however, is not intended to limit the scope of the present invention. In the specific example, the predetermined strength distribution corresponding to the transmission policy 10 is “the number of strong terminal apparatuses: the number of weak terminal apparatuses=1:1,” the predetermined strength distribution corresponding to the transmission policy 12 is “the number of strong terminal apparatuses: the number of weak terminal apparatuses=1:3,” and the predetermined strength distribution corresponding to the transmission policy 14 is “the number of strong terminal apparatuses: the number of weak terminal apparatuses=1:7.”

In addition, the transmission policies 10, 12, and 14 respectively comprises a first predetermined transmission mechanisms 10a, 12a, and 14a and respectively comprises a second predetermined transmission mechanisms 10b, 12b, and 14b. The first predetermined transmission mechanisms 10a, 12a, and 14a may correspond to a first strength level, and the second predetermined transmission mechanisms 10b, 12b, and 14b may correspond to a second strength level, wherein the first strength level is different from the second strength level.

In some embodiments, each of the first predetermined transmission mechanisms 10a, 12a, and 14a includes a plurality of first transmission count regulations, and each of the second predetermined transmission mechanisms 10b, 12b, and 14b includes a plurality of second transmission count regulations. Please refer to a specific example shown in FIG. 1B for better understanding, which, however, is not intended to limit the scope of the present invention. Take the first predetermined transmission mechanism 10a of the transmission policy 10 as an example, three first transmission count regulations are provided, including the probability that a piece of data can be transmitted twice (e.g., selecting two time slots) is 0.665, the probability that a piece of data can be transmitted for three times (e.g., selecting three time slots) is 0.1515, and the probability that a piece of data can be transmitted for eight times (e.g., selecting eight time slots) is 0.1835. In the specific example of FIG. 1B, each of the first predetermined transmission mechanism 10a, 12a, and 14a and the second predetermined transmission mechanism 10b, 12b, and 14b is recorded as a polynomial, but it should be appreciated that the aforesaid recording manner is not intended to limit the scope of the present invention.

Each of the terminal apparatuses 13a, . . . , 13b has attached to the determination apparatus 11 through an attach procedure. In this embodiment, the terminal apparatuses 13a, . . . , 13b already know the transmission policies 10, 12, and 14 of the determination apparatus 11. In other embodiment, the terminal apparatuses 13a, . . . , 13b do not know the transmission policies 10, 12, and 14 of the determination apparatus 11 in advance, so the transceiver 115 may transmit the transmission policies 10, 12, and 14 to the terminal apparatuses 13a, . . . , 13b after the terminal apparatuses 13a, . . . , 13b have attached to the determination apparatus 11.

In the attach procedure, the determination apparatus 11 is able to know the signal strength (not shown) of each of the terminal apparatuses 13a, . . . , 13b. The processor 113 of the determination apparatus 11 determines a real strength distribution among the terminal apparatuses 13a, . . . , 13b according to the signal strengths respectively corresponding to the terminal apparatuses 13a, . . . , 13b. Similarly, the real strength distribution may be a distribution of strong terminal apparatuses (e.g., terminal apparatuses whose signal strengths are strong from the viewpoint of the determination apparatus) and weak terminal apparatuses (e.g., terminal apparatuses whose signal strengths are weak from the viewpoint of the determination apparatus) in wireless communication system 1 (e.g., the ratio of the numbers of the strong terminal apparatuses to the number of the weak terminal apparatuses, or the percentage of these two types of terminal apparatus).

Next, the processor 113 of the determination apparatus 11 determines a selected policy (not shown) from the transmission policies 10, 12, and 14 based on the real strength distribution and the predetermined strength distributions. The processor 113 of the determination apparatus 11 further determines a user transmission mechanism for each of the terminal apparatuses 13a, . . . , 13b (not shown), wherein each of the user transmission mechanisms includes at least one of the first predetermined transmission mechanism and the second predetermined transmission mechanism of the selected policy. The processor 113 of the determination apparatus 11 adopts the user transmission mechanisms of the terminal apparatuses 13a, . . . , 13b as the network transmission mechanism of the wireless communication system 1. After the processor 113 determines the user transmission mechanism of each of the terminal apparatuses 13a, . . . , 13b, the transceiver 115 transmits the indication signals 20a, . . . , 20b to the terminal apparatuses 13a, . . . , 13b respectively to inform the terminal apparatuses 13a, . . . , 13b of the corresponding user transmission mechanism (e.g., the code of the corresponding user transmission mechanism). Each of the terminal apparatuses 13a, . . . , 13b then transmits data according to the corresponding user transmission mechanism. For example, if the user transmission mechanism of a terminal apparatus is the first predetermined transmission mechanism 10a, the terminal apparatus may generate, before transmitting a piece of data, a value between the integer 0 and the integer 1 by using a random number generator to determine the number of times (i.e., the count) that the piece of data can be transmitted. If the value is between 0 and 0.665, the piece of data can be transmitted twice (e.g., select two time slots). If the value is between 0.666 and 0.8165, the piece of data can be transmitted for three times (e.g., select three time slots). If the value is between 0.8166 and 1, the piece of data can be transmitted for eight times (e.g., select eight time slots).

In some embodiments, the processor 113 selects the transmission policy corresponding to the predetermined strength distribution that is closest to the real strength distribution as the selected policy. Since the selected policy is one of the transmission policies 10, 12, and 14, the first predetermined transmission mechanism of the selected policy and the second transmission mechanism of the selected policy also respectively correspond to the first strength level and the second strength level. For each of the terminal apparatuses 13a, . . . , 13b, the processor 113 may determine the terminal apparatus should use the first predetermined transmission mechanism of the selected policy or the second transmission mechanism of the selected policy based on the corresponding signal strength. Specifically, if the first strength level is higher than the second strength level, the processor 113 may determine that the strong terminal apparatuses among the terminal apparatuses 13a, . . . , 13b should use the first predetermined transmission mechanism of the selected policy and the weak terminal apparatuses among the terminal apparatuses 13a, . . . , 13b should use the second predetermined transmission mechanism. As stated above, after the processor 113 determines the user transmission mechanism of each of the terminal apparatuses 13a, . . . , 13b, the transceiver 115 transmits the indication signals 20a, . . . , 20b to the terminal apparatuses 13a, . . . , 13b respectively to inform the terminal apparatuses 13a, . . . , 13b of the corresponding user transmission mechanism. Each of the terminal apparatuses 13a, . . . , 13b then transmit data according to the corresponding user transmission mechanism. The details will not be repeated herein.

In some embodiments, the processor 113 determines whether the real strength distribution and any of the predetermined strength distributions is close enough. If the processor 113 determines that the real strength distribution and every predetermined strength distribution is not close enough, the processor 113 may directly designate the transmission policy corresponding to one of the predetermined strength distributions as the selected policy.

Since the selected policy is one of the transmission policies 10, 12, and 14, the first predetermined transmission mechanism and the second transmission mechanism of the selected policy also respectively correspond to the first strength level and the second strength level. The processor 113 determines that the terminal apparatuses 13a, . . . , 13b should adopt the first predetermined transmission mechanism of the selected policy and the second predetermined transmission mechanism of the selected policy according to a predetermined ratio, wherein the first predetermined transmission mechanism of the selected policy is used with the first strength level, and the second predetermined transmission mechanism of the selected policy is used with the second strength level. Similarly, after the processor 113 determines the user transmission mechanism of each of the terminal apparatuses 13a, . . . , 13b, the transceiver 115 transmits the indication signals 20a, . . . , 20b to the terminal apparatuses 13a, . . . , 13b respectively to inform the terminal apparatuses 13a, . . . , 13b of the corresponding user transmission mechanism. Each of the terminal apparatuses 13a, . . . , 13b then transmits data according to the corresponding user transmission mechanism.

For example, if the real strength distribution is a ratio showing that the number of strong terminal apparatuses and the number of weak terminal apparatuses are with large disparity (e.g., “the number of strong terminal apparatuses : the number of weak terminal apparatuses=0:100”), the processor 113 will determine that the real strength distribution and all the predetermined strength distributions are not close enough. If the real strength distribution is a ratio showing that the number of strong terminal apparatuses and the number of weak terminal apparatuses are with large disparity, it means that the terminal apparatuses 13a, . . . , 13b are homogeneous apparatuses in terms of signal strength. Accordingly, the processor 113 may designate the transmission policy 10 as the selected policy and designate the terminal apparatuses 13a, . . . , 13b to adopt the first predetermined transmission mechanism of the selected policy and the second predetermined transmission mechanism of the selected policy according to a predetermined ratio (for example, using the first predetermined transmission mechanism and the second predetermined transmission mechanism by turns, that is, a ratio of 1:1), wherein the first predetermined transmission mechanism of the selected policy is used with the first strength level, and the second predetermined transmission mechanism of the selected policy is used with the second strength level. Assumed that the first strength level is higher than the second strength level. Each of the terminal apparatuses 13a, . . . , 13b will increase the power value for transmitting data based on the first strength level when there is a need in transmitting data according to the first predetermined transmission mechanism. Similarly, each of the terminal apparatuses 13a, . . . , 13b will decrease the power value for transmitting data based on the second strength level when there is a need in transmitting data according to the second predetermined transmission mechanism.

After the processor 113 receives the data transmitted from the terminal apparatuses 13a, . . . , 13b, the processor 113 will decode each of the transmission resources (e.g., time slot). Specifically, the processor 113 adopts Non-Orthogonal Multiple Access (NOMA) technology to decode the data of every transmission resource. If there is only a piece of data in a transmission resource (no matter the piece of data is transmitted with the first strength level or the second strength level), the processor 113 is able to decode the piece of data from the transmission resource. In addition, if there are two pieces of data transmitted with different signal strengths in a transmission resource, the processor 113 still can decode the two pieces of data from the transmission resource due to adopting the NOMA technology. Specifically, if there are two pieces of data transmitted with different signal strengths in a transmission resource, the processor 113 derives the first data transmitted with a higher strength level by decoding the superimposed signal of the transmission resource and then derives the second data transmitted with a lower strength level by cancelling the portion of the first data from the superimposed signal and then decoding the signal that has been cancelled by the portion of the first data.

In some embodiments, the determination apparatus 11 further provides a charging mechanism. The determination apparatus 11 may calculate a transmission fee based on the average transmission count (i.e., the number of times, on average, that a same piece of data been transmitted) for each of the terminal apparatuses 13a, . . . , 13b. The details are given herein by taking a specific terminal apparatus (e.g., the terminal apparatus 13a) of the terminal apparatuses 13a, . . . , 13b as an example. The transceiver 115 receives a plurality of pieces of data D1, . . . , Dn of the terminal apparatus 13a, the processor 113 calculates an average transmission count of the terminal apparatus 13a according to the pieces of data D1, . . . , Dn, and the processor 113 then calculates a transmission fee of the terminal apparatus 13a according to the average transmission count.

In some embodiments, the determination apparatus 11 may further monitor the terminal apparatuses 13a, . . . , 13b to see if they comply with the corresponding user transmission mechanisms and punish the terminal apparatus(es) that do(es) not comply with the corresponding user transmission mechanism. The details are given herein by taking a specific terminal apparatus (e.g., the terminal apparatus 13a) of the terminal apparatuses 13a, . . . , 13b as an example. The transceiver 115 receives a plurality of pieces of data D1, . . . , Dn of the terminal apparatus 13a, the processor 113 calculates an average transmission count of the terminal apparatus 13a according to the pieces of data D1, Dn, and the processor 113 then determines that the average transmission count does not comply with the user transmission mechanism of the terminal apparatus 13a. Since the terminal apparatus 13a does not comply with the corresponding user transmission mechanism, the processor 113 suspends the service for the terminal apparatus 13a. In some embodiments, for the terminal apparatuses which do not comply with the corresponding transmission mechanism (e.g., the terminal apparatus 13a), the processor 113 calculates an additional fee based on the average transmission count.

From the above description, it is understood that the determination apparatus 11 utilizes the characteristic of NOMA technology that two pieces of data transmitted with different signal strengths can be decoded from a transmission resource. The determination apparatus 11 formulates a plurality of transmission policies, wherein each of the transmission policies corresponds to a predetermined strength distribution and each of the transmission policies includes a first predetermined transmission mechanism and a second predetermined transmission mechanism. Besides, each of the first predetermined transmission mechanisms corresponds to a first strength level, and each of the second predetermined transmission mechanisms corresponds to a second strength level. The determination apparatus 11 selects one of the transmission policies 10, 12, and 14 as a selected policy based on a real strength distribution of all the terminal apparatuses 13a, . . . , 13b in the wireless communication system 1. Then, the determination apparatus 11 have some terminal apparatuses in the wireless communication system 1 adopt the first predetermined transmission mechanism of the selected policy and have the rest terminal apparatuses in the wireless communication system 1 adopt the second predetermined transmission mechanism of the selected policy. By the aforementioned approach, the determination apparatus 11 can increase the probability that two pieces of data in the same transmission resource are transmitted with different signal strengths and thereby make the wireless communication system 1 have a high transmission efficiency. In addition, because the determination apparatus 11 does not need to coordinate transmission resources among the terminal apparatuses 13a, . . . , 13b in advance, system resources will not be consumed severely.

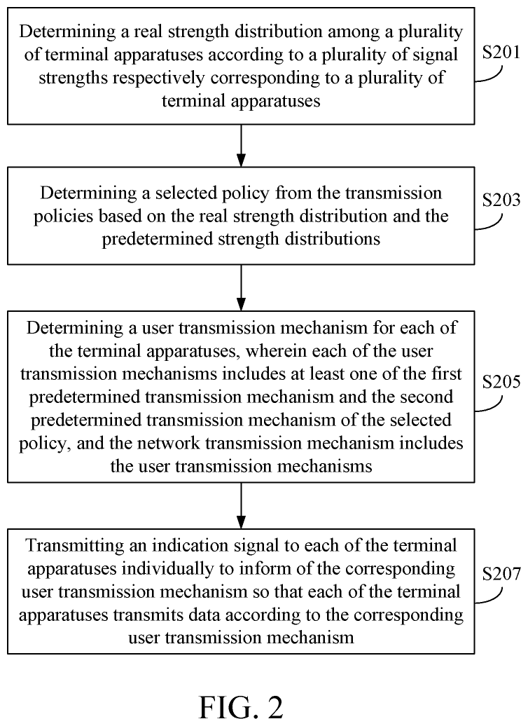

A second embodiment of the present invention is a method for determining a network transmission mechanism, and a main flowchart thereof is depicted in FIG. 2. The method is for use in an electronic computing apparatus (e.g., the determination apparatus 11). The electronic computing apparatus stores a plurality of transmission policies, wherein each of the transmission policies corresponds to a predetermined strength distribution, and each of the transmission policies includes a first predetermined transmission mechanism and a second predetermined transmission mechanism. Each of the first predetermined transmission mechanism corresponds to a first strength level, and each of the second predetermined transmission mechanism corresponds to a second strength level. In some embodiments, each of the first predetermined transmission mechanism includes a plurality of first transmission count regulations, and each of the second predetermined transmission mechanism includes a plurality of second transmission count regulations.

In this embodiment, the method comprises step S201 to step S207. In the step S201, the electronic computing apparatus determines a real strength distribution among a plurality of terminal apparatuses according to a plurality of signal strengths respectively corresponding to the terminal apparatuses. In the step S203, the electronic computing apparatus determines a selected policy from the transmission policies based on the real strength distribution and the predetermined strength distributions. In step S205, the electronic computing apparatus determining a user transmission mechanism for each of the terminal apparatuses, wherein each of the user transmission mechanisms includes at least one of the first predetermined transmission mechanism and the second predetermined transmission mechanism of the selected policy, and the network transmission mechanism includes the user transmission mechanisms. In the step S207, the electronic computing apparatus transmits an indication signal to each of the terminal apparatuses individually to inform of the corresponding user transmission mechanism so that each of the terminal apparatuses transmits data according to the corresponding user transmission mechanism.

In this embodiment, the terminal apparatuses already know the transmission policies of the electronic computing apparatus. In other embodiment, if the terminal apparatuses do not know the transmission policies of the electronic computing apparatus in advance, the method further comprises a step to transmit the transmission policies to each of the terminal apparatuses.

In some embodiments, the step S203 selects the transmission policy corresponding to the predetermined strength distribution that is closest to the real strength distribution as the selected policy, and the step S205 determines that each of the user transmission mechanisms is one of the first predetermined transmission mechanism and the second predetermined transmission mechanism of the selected policy based on the signal strength of each of the terminal apparatuses.

In some embodiments, the step S203 determines that the real strength distribution and every predetermined strength distribution is not close enough and, thus, directly designates the transmission policy corresponding to one of the predetermined strength distributions as the selected policy. In those embodiments, each of the user transmission mechanisms determined in the step S205 includes the first predetermined transmission mechanism and the second predetermined transmission mechanism of the selected policy. Each of the terminal apparatuses will adopt the first predetermined transmission mechanism of the selected policy and the second predetermined transmission mechanism of the selected policy according to a predetermined ratio, wherein the first predetermined transmission mechanism of the selected policy is used with the first strength level, and the second predetermined transmission mechanism of the selected policy is used with the second strength level.

In some embodiments, the method further provides a charging mechanism. Specifically, for a specific terminal apparatus of the terminal apparatuses, the method may comprise a step to receive a plurality pieces of data of the specific terminal apparatus, a step to calculate an average transmission count of the specific terminal apparatus according to the pieces of data, and a step to calculate a transmission fee of the specific terminal apparatus according to the average transmission count.

In some embodiments, the method further provides a punishment mechanism to punish the terminal apparatuses which do not comply with the corresponding user transmission mechanism. Specifically, for a specific terminal apparatus of the terminal apparatuses, the method may include a step to receive a plurality of pieces of data of a specific terminal apparatus of the terminal apparatuses, a step to calculate an average transmission count of the specific terminal apparatus according to the pieces of data, a step to determine that the average transmission count does not comply with the user transmission mechanism of the specific terminal apparatus, and a step to suspend the service for the specific terminal apparatus.

In some embodiments, the method further provides another punishment mechanism to punish the terminal apparatuses which do not comply with the corresponding user transmission mechanism. Specifically, for a specific terminal apparatus of the terminal apparatuses, the method may include a step to receive a plurality of pieces of data of a specific terminal apparatus of the terminal apparatuses, a step to calculate an average transmission count of the specific terminal apparatus according to the pieces of data, a step to determine that the average transmission count does not comply with the user transmission mechanism of the specific terminal apparatus, and a step to calculate an additional fee of the specific terminal apparatus.

In addition to the aforesaid steps, the second embodiment can execute all the operations and steps executed by the determination apparatus 11, have the same functions, and deliver the same technical effects as the determination apparatus 11. How the second embodiment executes these operations and steps, has the same functions, and delivers the same technical effects as the determination apparatus 11 will be readily appreciated by a person having ordinary skill in the art based on the above explanation of the determination apparatus 11 and, thus, the details will not be further described herein.

It shall be appreciated that, in the specification and the claims of the present invention, some terms (including predetermined transmission mechanism, strength level, data) are preceded by the terms “first” or “second.” Please note that the terms “first” and “second” are used only for distinguishing different terms.

According to the above descriptions, the technology (including at least the wireless communication system and the apparatus and method for determining a network transmission mechanism) provided by the present invention utilizes the characteristic of NOMA technology that two pieces of data transmitted with different signal strengths can be decoded from a transmission resource. The technology provided by the present invention formulates a plurality of transmission policies, wherein each of the transmission policies corresponds to a predetermined strength distribution, and each of the transmission policies includes a first predetermined transmission mechanism and a second predetermined transmission mechanism. Besides, each of the first predetermined transmission mechanisms corresponds to a first strength level, and each of the second predetermined transmission mechanisms corresponds to a second strength level. The technology provided by the present invention further selects one of the transmission policies as a selected policy based on a real strength distribution of all the terminal apparatuses in the wireless communication system. Then, the technology provided by the present invention have some terminal apparatuses in the wireless communication system adopt the first predetermined transmission mechanism of the selected policy and have the rest terminal apparatuses in the wireless communication system adopt the second predetermined transmission mechanism of the selected policy. By the aforementioned approach, the technology provided by the present invention can increase the probability that two pieces of data in the same transmission resource are transmitted with different signal strengths and thereby make the wireless communication system have a high transmission efficiency. In addition, because the technology provided by the present invention works well even without coordinating transmission resources among multiple terminal apparatuses in advance, additional system resources for coordination is not consumed.

The above disclosure is only utilized to enumerate some embodiments of the present invention and illustrated technical features thereof, which is not used to limit the scope of the present invention. A person having ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for determining a network transmission mechanism, comprising:
a storage, being configured to store a plurality of transmission policies, wherein each of the transmission policies corresponds to a predetermined strength distribution, and each of the transmission policies includes a first predetermined transmission mechanism and a second predetermined transmission mechanism;
a processor, being electrically connected to the storage and configured to determine a real strength distribution among a plurality of terminal apparatuses according to a plurality of signal strengths respectively corresponding to the terminal apparatuses, determine a selected policy from the transmission policies based on the real strength distribution and the predetermined strength distributions, and determine a user transmission mechanism for each of the terminal apparatuses, wherein each of the user transmission mechanisms includes at least one of the first predetermined transmission mechanism and the second predetermined transmission mechanism of the selected policy, and the network transmission mechanism includes the user transmission mechanisms; and
a transceiver, being electrically connected to the processor and configured to transmit an indication signal to each of the terminal apparatuses individually to inform of the corresponding user transmission mechanism so that each of the terminal apparatuses transmits data according to the corresponding user transmission mechanism.

2. The apparatus of claim 1, wherein each of the first transmission mechanisms includes a plurality of first transmission count regulations, and each of the second transmission mechanisms includes a plurality of second transmission count regulations.

3. The apparatus of claim 1, wherein the processor selects the transmission policy corresponding to the predetermined strength distribution that is closest to the real strength distribution as the selected policy, the first predetermined transmission mechanism and the second predetermined transmission mechanism of the selected policy respectively correspond to a first strength level and a second strength level, and the processor determines that each of the user transmission mechanisms is one of the first predetermined transmission mechanism and the second predetermined transmission mechanism of the selected policy based on the signal strength of each of the terminal apparatuses.

4. The apparatus of claim 1, wherein the first predetermined transmission mechanism and the second transmission mechanism of the selected policy respectively correspond to a first strength level and a second strength level, and each of the user transmission mechanisms includes the first predetermined transmission mechanism and the second predetermined transmission mechanism of the selected policy, wherein each of the terminal apparatuses adopts the first predetermined transmission mechanism of the selected policy and the second predetermined transmission mechanism of the selected policy according to a predetermined ratio, the first predetermined transmission mechanism of the selected policy is used with the first strength level, and the second predetermined transmission mechanism of the selected policy is used with the second strength level.

5. The apparatus of claim 1, wherein the transceiver further receives a plurality of pieces of data of a specific terminal apparatus among the terminal apparatuses, the processor further calculates an average transmission count of the specific terminal apparatus according to the pieces of data, and the processor further calculates a transmission fee of the specific terminal apparatus according to the average transmission count.

6. The apparatus of claim 1, wherein the transceiver further receives a plurality of pieces of data of a specific terminal apparatus among the terminal apparatuses, the processor further calculates an average transmission count of the specific terminal apparatus according to the pieces of data, the processor further determines that the average transmission count violates the user transmission mechanism of the specific terminal apparatus, and the processor further suspends the service for the specific terminal apparatus.

7. The apparatus of claim 1, wherein the transceiver further receives a plurality of pieces of data of a specific terminal apparatus among the terminal apparatuses, the processor further calculates an average transmission count of the specific terminal apparatus according to the pieces of data, the processor further determines that the average transmission count violates the user transmission mechanism of the specific terminal apparatus, and the processor further calculates an additional fee of the specific terminal apparatus.

8. The apparatus of claim 1, wherein the transceiver further transmits the transmission policies to each of the terminal apparatuses.

9. A method for determining a network transmission mechanism, being adapted for use in an electronic computing apparatus, the electronic computing apparatus storing a plurality of transmission policies, each of the transmission policies corresponding to a predetermined strength distribution, each of the transmission policies including a first predetermined transmission mechanism and a second predetermined transmission mechanism, and the method comprising the following steps:
(a) determining a real strength distribution among a plurality of terminal apparatuses according to a plurality of signal strengths respectively corresponding to the terminal apparatuses;
(b) determining a selected policy from the transmission policies based on the real strength distribution and the predetermined strength distributions;
(c) determining a user transmission mechanism for each of the terminal apparatuses, wherein each of the user transmission mechanisms includes at least one of the first predetermined transmission mechanism and the second predetermined transmission mechanism of the selected policy; and
(d) transmitting an indication signal to each of the terminal apparatuses individually to inform of the corresponding user transmission mechanism so that each of the terminal apparatuses transmits data according to the corresponding user transmission mechanism.

10. The method of claim 9, wherein each of the first transmission mechanisms includes a plurality of first transmission count regulations, and each of the second transmission mechanisms includes a plurality of second transmission count regulations.

11. The method of claim 9, wherein the step (b) selects the transmission policy corresponding to the predetermined strength distribution that is closest to the real strength distribution as the selected policy, the first predetermined transmission mechanism and the second predetermined transmission mechanism of the selected policy respectively corresponding to a first strength level and a second strength level, and the step (c) determines that each of the user transmission mechanisms is one of the first predetermined transmission mechanism and the second predetermined transmission mechanism of the selected policy based on the signal strength of each of the terminal apparatuses.

12. The method of claim 9, wherein the first predetermined transmission mechanism and the second transmission mechanism of the selected policy respectively correspond to a first strength level and a second strength level, and each of the user transmission mechanisms includes the first predetermined transmission mechanism and the second predetermined transmission mechanism of the selected policy, wherein each of the terminal apparatuses adopts the first predetermined transmission mechanism of the selected policy and the second predetermined transmission mechanism of the selected policy according to a predetermined ratio, the first predetermined transmission mechanism of the selected policy is used with the first strength level, and the second predetermined transmission mechanism of the selected policy is used with the second strength level.

13. The method of claim 9, further comprising the following steps of:
receiving a plurality of pieces of data of a specific terminal apparatus among the terminal apparatuses;
calculating an average transmission count of the specific terminal apparatus according to the pieces of data; and
calculating a transmission fee of the specific terminal apparatus according to the average transmission count.

14. The method of claim 9, further comprising the following steps of:
receiving a plurality of pieces of data of a specific terminal apparatus among the terminal apparatuses;
calculating an average transmission count of the specific terminal apparatus according to the pieces of data;
determining that the average transmission count violate the user transmission mechanism; and
suspending the service for the specific terminal apparatus.

15. The method of claim 9, further comprising the following steps of:
receiving a plurality of pieces of data of a specific terminal apparatus among the terminal apparatuses;
calculating an average transmission count of the specific terminal apparatus according to the pieces of data;
determining that the average transmission count violate the user transmission mechanism; and
calculating an additional fee of the specific terminal apparatus.

16. The method of claim 9, further comprising the following step of:
transmitting the transmission policies to each of the terminal apparatuses.

17. A wireless communication system, comprising:
an electronic computing apparatus, being configured to store a plurality of transmission policies, wherein each of the transmission policies corresponds to a predetermined strength distribution and each of the transmission policies includes a first predetermined transmission mechanism and a second predetermined transmission mechanism; and
a plurality of terminal apparatuses, being attached to the electronic computing apparatus,
wherein the electronic computing apparatus determines a real strength distribution among the terminal apparatuses according to a plurality of signal strengths respectively corresponding to the terminal apparatuses, determines a selected policy from the transmission policies based on the real strength distribution and the predetermined strength distributions, and determines a user transmission mechanism for each of the terminal apparatuses, wherein each of the user transmission mechanisms includes at least one of the first predetermined transmission mechanism and the second predetermined transmission mechanism of the selected policy, and the network transmission mechanism includes the user transmission mechanisms,
wherein the electronic computing apparatus further transmits an indication signal to each of the terminal apparatuses individually to inform of the corresponding user transmission mechanism, and each of the terminal apparatuses transmits data according to the corresponding user transmission mechanism.

18. The wireless communication system of claim 17, wherein each of the first transmission mechanisms includes a plurality of first transmission count regulations, and each of the second transmission mechanisms includes a plurality of second transmission count regulations.

19. The wireless communication system of claim 17, wherein the electronic computing apparatus selects the transmission policy corresponding to the predetermined strength distribution that is closest to the real strength distribution as the selected policy, the first predetermined transmission mechanism and the second predetermined transmission mechanism of the selected policy respectively corresponding to a first strength level and a second strength level, and the electronic computing apparatus determines that each of the user transmission mechanism is one of the first predetermined transmission mechanism and the second predetermined transmission mechanism of the selected policy based on the signal strength of each of the terminal apparatuses.

20. The wireless communication system of claim 17, wherein the first predetermined transmission mechanism and the second transmission mechanism of the selected policy respectively correspond to a first strength level and a second strength level, and each of the user transmission mechanisms includes the first predetermined transmission mechanism and the second predetermined transmission mechanism, wherein each of the terminal apparatuses adopts the first predetermined transmission mechanism of the selected policy and the second predetermined transmission mechanism of the selected policy according to a predetermined ratio, the first predetermined transmission mechanism of the selected policy is used with the first strength level, and the second predetermined transmission mechanism of the selected policy is used with the second strength level.
